(19) United States
(12) Patent Application Publication
(10) Pub. No.: US 2016/0080968 A1
(43) Pub. Date: Mar. 17, 2016

(54) METHOD AND APPARATUS FOR CONTROLLING TRAFFIC IN WLAN SYSTEM

(71) Applicant: KT CORPORATION, Gyeonggi-do (KR)

(72) Inventors: Yang Seok JEONG, Seoul (KR); Joo Young KIM, Seoul (KR)

(73) Assignee: KT CORPORATION, Gyeonggi-do (KR)

(21) Appl. No.: 14/786,201

(22) PCT Filed: Jun. 24, 2014
(86) PCT No.: PCT/KR2014/005580

§ 371 Date: Oct. 22, 2015

(30) Foreign Application Priority Data
Jun. 24, 2013 (KR) 10-2013-0072725

(51) Int. Cl. H04W 28/02

(52) U.S. Cl. CPC H04W 28/0236; H04W 84/12

(57) ABSTRACT

An apparatus and a method for controlling traffic in a wireless local area network (WLAN) system are disclosed. The method for controlling traffic in a WLAN system comprises the steps of: setting a pause condition to stop data transmission from a user equipment to an access point; generating a pause frame including the pause condition and a pause period during which data transmission is stopped; and transmitting the pause frame. Therefore, the present invention can improve the efficiency of a WLAN system.

### TECHNICAL FIELD

The present invention generally relates to traffic control technology in a wireless local area network (WLAN) system and, more particularly, to a method and apparatus for controlling traffic in a relay device that relays data transmitted between an access point and a terminal.

### BACKGROUND ART

With the development of information and communication technology, various wireless communication technologies have been developed. Among these technologies, a wireless local area network (WLAN) denotes technology for allowing wireless access to the Internet in homes, businesses or specific service areas using a mobile terminal such as a personal digital assistant (PDA), a laptop computer, a portable multimedia player (PMP), a smart phone, or a tablet PC, based on radio frequency (RF) technology.

Standards for WLAN technology have been developed as Institute of Electrical and Electronics Engineers (IEEE) 802.11 standards. WLAN technology conforming to the IEEE 802.11a standard is operated based on an orthogonal frequency division multiplexing (OFDM) scheme, and is capable of providing a maximum data rate of 54 Mbps in a 5 GHz band. WLAN technology conforming to the IEEE 802.11b standard is operated based on a direct sequence spread spectrum (DSSS) scheme, and is capable of providing a maximum data rate of 11 Mbps in a 2.4 GHz band. WLAN technology conforming to the IEEE 802.11g standard is operated based on the OFDM or DSSS scheme, and is capable of providing a maximum data rate of 54 Mbps in a 2.4 GHz band.

WLAN technology conforming to the IEEE 802.11n standard is operated based on the OFDM scheme in a 2.4 GHz band and a 5 GHz band, and is capable of providing a maximum data rate of 300 Mbps for four spatial streams when a Multiple-Input Multiple-Output OFDM (MIMO-OFDM) scheme is used. WLAN technology conforming to the IEEE 802.11n standard may support a channel bandwidth of up to 40 MHz and is capable of providing a maximum data rate of 600 Mbps in that case.

As the popularization of such WLAN technology has been activated and applications using WLANs have been diversified, the requirement for new WLAN technology that supports throughput higher than that of existing WLAN technology is increasing. Very high throughput (VHT) WLAN technologies are technologies proposed to support data processing speeds of 1 Gbps or more. Among these technologies, WLAN technology conforming to the IEEE 802.11ac standard is technology for providing very high throughput (VHT) in a band of 6 GHz or less, and WLAN technology conforming to the IEEE 802.11ad standard is technology for providing VHT in a 60 GHz band.

In addition, standards for various WLAN technologies have been established, and technologies are being developed. As representatives thereof, WLAN technology conforming to the IEEE 802.11af standard is technology defined for the operation of a WLAN in TV white space, WLAN technology conforming to the IEEE 802.11ah is technology defined to support a large number of terminals operating on low power, and WLAN technology conforming to the IEEE 802.11ai standard is technology defined for fast initial link setup (FILS) in a WLAN system. Recently, in a congested environment in which multiple base stations and terminals are present, the standardization of an IEEE 802.11 high-efficiency WLAN (HEW), aimed at improving frequency use efficiency, is ongoing.

In a system based on such WLAN technology, any terminal may act as a relay device for relaying data transmitted between an access point and an end terminal. Generally, a relay device simultaneously transmits frames received from multiple end terminals to the access point, rather than transmitting a received frame to the access point whenever the frame is received from each end terminal.

A terminal acting as a relay device has a small buffer. In this environment, when the state of the wireless channel between the relay device and the access point is deteriorated, latency in data transmission occurs, thus resulting in overflow of the buffer.

When such buffer overflow occurs, the relay device cannot receive frames transmitted from end terminals. In this case, since each end terminal cannot receive an acknowledgement (ACK) frame, which is a response to the transmitted frame, and cannot recognize that the failure to transmit the frame is due to the buffer overflow, the end terminal continuously retransmits the frame to the relay device. Due to such frame retransmission, the efficiency of use of the wireless channel is rapidly deteriorated. Further, since an end terminal must be maintained in an awakened state in order to retransmit the frame, power consumption is increased.

### DISCLOSURE

### Technical Problem

An object of the present invention to solve the above problems is to provide a method for improving the efficiency of a WLAN system that supports a communication service for multiple terminals located over a wide area.

Another object of the present invention to solve the above problems is to provide a method for reducing power consumption by an end terminal in a WLAN system including a relay device.

### Technical Solution

A traffic control method according to an embodiment of the present invention to accomplish the above object includes configuring a suspend condition, required to suspend transmission of data from a terminal to an access point, generating a suspend frame including both the suspend condition and a suspend duration for data transmission, and transmitting the suspend frame.

Here, the suspend condition may be configured to suspend transmission of data from a specific terminal.

Here, the suspend condition may be configured to suspend transmission of specific data.

Here, the suspend condition may include at least one of a group ID, an association ID (AID), a modulation and coding scheme (MCS) level, and a service type.

Here, the suspend condition may include at least one of length of data to be transmitted, a amount of generated jitter, a amount of generated latency, and a traffic category.

A traffic control method according to another embodiment of the present invention to accomplish the above object includes determining a resume condition, required to resume transmission of data from a terminal to an access point, generating a resume frame including the resume condition, and transmitting the resume frame.

Here, the resume condition may be configured to resume transmission from a specific terminal.

Here, the resume condition may be configured to resume transmission of specific data.

Here, the resume condition may include at least one of a group ID, an association ID (AID), a modulation and coding scheme (MCS) level, and a service type.

Here, the resume condition may include at least one of length of data to be transmitted, a amount of generated jitter, a amount of generated latency, and a traffic category.

A data transmission method according to an embodiment of the present invention to accomplish the other object includes receiving a suspend frame from an access point, acquiring both a suspend condition, required to suspend transmission of data from a terminal to the access point, and a suspend duration for data transmission, the suspend condition and the suspend duration being included in the suspend frame, and suspending transmission of data to the access point during the suspend duration when the suspend condition is met.

Here, the suspend condition may be configured to suspend transmission of data from a specific terminal.

Here, the suspend condition may be configured to suspend transmission of specific data.

A data transmission method according to another embodiment of the present invention to accomplish the other object includes receiving a resume frame from an access point, acquiring a resume condition, required to resume transmission of data from a terminal to the access point, the resume condition being included in the resume frame, and resuming transmission of data to the access point when the resume condition is met.

Here, the resume condition may be configured to resume transmission from a specific terminal.

Here, the resume condition may be configured to resume transmission of specific data.

### Advantageous Effects

In accordance with the present invention, an access point may extend a service area via a relay device. Since a terminal may secure a high-quality link via the relay device, it may transmit data at high speed. That is, since the relay device is used, the efficiency of use of a wireless channel may be improved, and thus power consumption of the terminal may be reduced.

Further, the relay device may control the transmission of data from the end terminal, so that buffer overflows may be prevented, and thus the unnecessary retransmission of data from the terminal may be prevented.

Furthermore, since the relay device is capable of controlling the transmission of data from the end terminal based on the characteristics of traffic, the characteristics of the end terminal, etc., the Quality of Service (QoS) of services having high priority may be guaranteed.

### DESCRIPTION OF DRAWINGS

FIG. 1 is a block diagram showing an embodiment of a station for performing methods according to the present invention;

FIG. 2 is a conceptual diagram showing an embodiment of the configuration of a WLAN system conforming to IEEE 802.11;

FIG. 3 is a flowchart showing a terminal association procedure in an infrastructure BSS;

FIG. 4 is a conceptual diagram showing the infrastructure BSS of a WLAN system;

FIG. 5 is a block diagram showing an embodiment of a hierarchical AID structure;

FIG. 6 is a block diagram showing an embodiment of the structure of a TIM information element (IE);

FIG. 7 is a block diagram showing an embodiment of the structure of a TIM encoded on a block basis;

FIG. 8 is a flow diagram showing an embodiment of a data transmission/reception procedure;

FIG. 9 is a conceptual diagram showing a WLAN system including relay devices;

FIG. 10 is a block diagram showing the logical configuration of a relay device;

FIG. 11 is a table showing an example of a relay control frame;

FIG. 12 is a flowchart showing a traffic control method according to an embodiment of the present invention;

FIG. 13 is a table showing a relay suspend frame according to an embodiment of the present invention;

FIG. 14 is a flowchart showing a traffic control method according to another embodiment of the present invention;

FIG. 15 is a table showing a relay resume frame according to an embodiment of the present invention;

FIG. 16 is a flowchart showing a relay traffic control procedure according to an embodiment of the present invention;

FIG. 17 is a flowchart showing a relay traffic control procedure according to another embodiment of the present invention; and

FIG. 18 is a flowchart showing a relay traffic control procedure according to a further embodiment of the present invention.

### BEST MODE

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms such as “first” and “second” may be used to describe various components, but those components should not be limited by the terms. The terms are merely used to distinguish one component from other components. A first component may be designated as a second component and a second component may be designated as a first component in the similar manner, without departing from the scope based on the concept of the present invention. The term “and/or” includes a combination of a plurality of related items or any of the plurality of related items.

It should be understood that a representation indicating that a first component is “connected” or “coupled” to a second component may include the case where the first component is connected or coupled to the second component with some other component interposed therebetween, as well as the case where the first component is “directly connected” or “directly coupled” to the second component. In contrast, it should be understood that a representation indicating that a first component is “directly connected” or “directly coupled” to a second component means that no component is interposed between the first and second components.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Hereinafter, preferred embodiments of the present invention will be described in detail with reference to the attached drawings. For easy understanding of the entire part of the invention in the following description of the present invention, the same reference numerals are used to designate the same or similar elements throughout the drawings, and repeated descriptions of the same components will be omitted.

Throughout the present specification, a station (STA) denotes any functional medium that includes medium access control (MAC) conforming to the IEEE 802.11 standards and a physical layer interface for a wireless medium. Stations may be classified into a station (STA) that is an access point (AP) and a station (STA) that is a non-AP. The station that is an AP may be simply called an access point (AP), and the station that is a non-AP may be simply called a terminal.

A ‘station (STA)’ may include a processor and a transceiver, and may further include a user interface, a display device, etc. The processor denotes a unit devised to generate a frame to be transmitted over a wireless network or process a frame received over the wireless network, and may perform various functions to control the station (STA). The transceiver denotes a unit that is functionally connected to the processor and is devised to transmit and receive a frame over the wireless network for the station (STA).

An ‘access Point (AP)’ may denote a centralized controller, a base station (BS), a radio access station, a Node B, an evolved Node B, a relay, a Mobile Multihop Relay (MMR)-BS, a Base Transceiver System (BTS), a site controller, etc., and may include some or all of the functions thereof.

A ‘terminal (i.e. non-AP)’ may denote a Wireless Transmit/Receive Unit (WTRU), User Equipment (UE), a User Terminal (UT), an Access Terminal (AT), a Mobile Station (MS), a mobile terminal, a subscriber unit, a Subscriber Station (SS), a wireless device, a mobile subscriber unit, etc., and may include some or all of the functions thereof.

Here, the terminal may denote a desktop computer capable of communication, a laptop computer, a tablet PC, a wireless phone, a mobile phone, a smart phone, a smart watch, smart glasses, an e-book reader, a Portable Multimedia Player (PMP), a portable game console, a navigation device, a digital camera, a Digital Multimedia Broadcasting (DMB) player, a digital audio recorder, a digital audio player, a digital picture recorder, a digital picture player, a digital video recorder, a digital video player, etc.

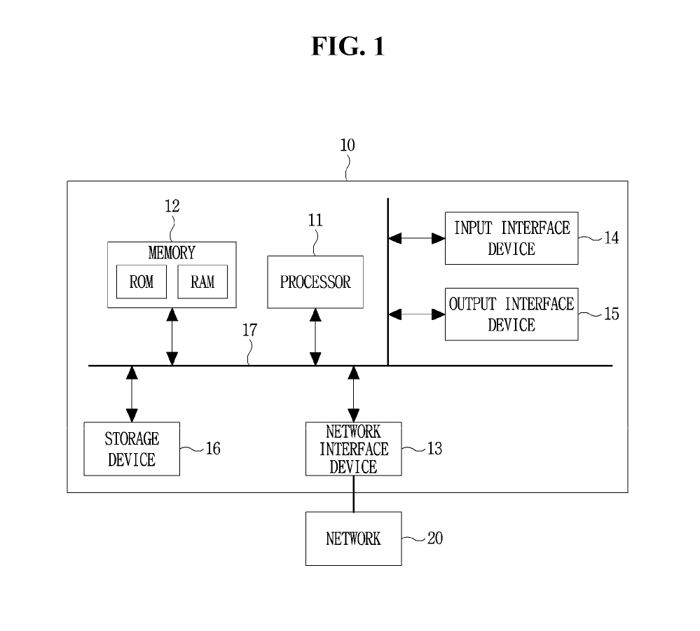

FIG. 1 is a block diagram showing an embodiment of a station for performing methods according to the present invention.

Referring to FIG. 1, a station 10 may include at least one processor 11, memory 12, and a network interface device 13 connected to a network 20 and configured to perform communication. The station 10 may further include an input interface device 14, an output interface device 15, and a storage device 16. The components included in the station 10 may be connected to each other through a bus 17, and may then perform communication with each other.

The processor 11 may execute program instructions stored in the memory 12 and/or the storage device 16. The processor 11 may denote a central processing unit (CPU), a graphics processing unit (GPU), or an exclusive processor for performing the methods according to the present invention. Each of the memory 12 and the storage device 16 may be implemented as a volatile storage medium and/or a nonvolatile storage medium. For example, the memory 12 may be implemented as read only memory (ROM) and/or random access memory (RAM).

The embodiments of the present invention are applied to a WLAN system conforming to the IEEE 802.11 standards, and may also be applied to other communication systems as well as the WLAN system conforming to the IEEE 802.11 standards.

For example, the embodiments of the present invention may be applied to the mobile Internet such as a Wireless Personal Area Network (WPAN), a Wireless Body Area Network (WBAN), Wireless Broadband Internet (WiBro), or Worldwide Interoperability for Microwave Access (Wimax), a second generation (2G) mobile communication network such as a Global System for Mobile communication (GSM) or Code Division Multiple Access (CDMA), a 3G mobile communication network such as Wideband Code Division Multiple Access (WCDMA) or CDMA2000, a 3.5G mobile communication network such as High-Speed Downlink Packet Access (HSDPA) or High-Speed Uplink Packet Access (HSUPA), a 4G mobile communication network such as Long-Term Evolution (LTE) or LTE-Advanced, or a 5G mobile communication network.

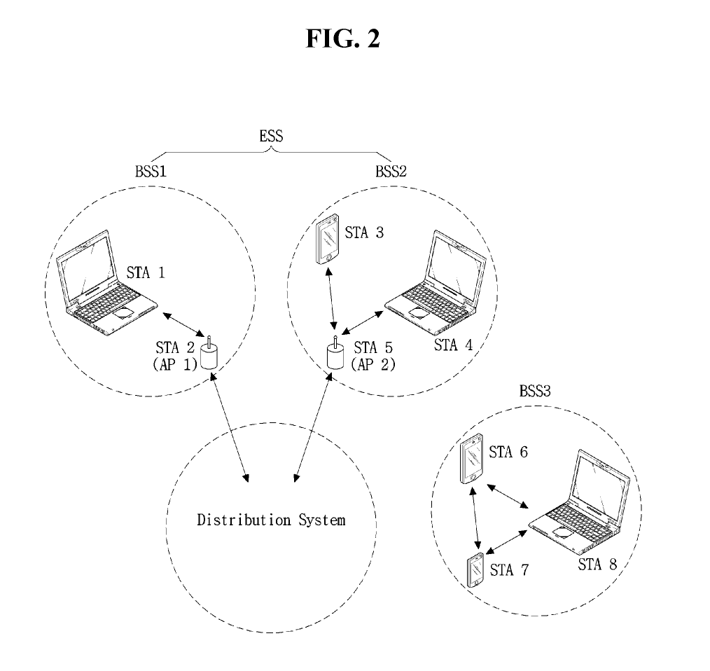

FIG. 2 is a conceptual diagram showing an embodiment of the configuration of a WLAN system conforming to IEEE 802.11.

Referring to FIG. 2, the WLAN system conforming to IEEE 802.11 may include at least one basic service set (BSS). The BSS denotes a set of stations (STA 1, STA 2 (AP 1), STA 3, STA 4, STA 5 (AP 2), STA 6, STA 7, STA 8) which are successfully synchronized with each other and are capable of communicating with each other, and is not a concept meaning a specific area.

BSSs may be classified into an infrastructure BSS and an independent BSS (IBSS). Here, BSS 1 and BSS 2 denote infrastructure BSSs and BSS 3 denotes an IBSS.

BSS 1 may include a first terminal STA 1, a first access point STA 2 (AP 1) for providing a distribution service, and a distribution system (DS) for connecting multiple access points STA 2 (AP 1) and STA 5 (AP 2) to each other. In BSS 1, the first access point STA 2 (AP 1) may manage the first terminal STA 1.

BSS 2 may include a third terminal STA 3, a fourth terminal STA 4, a second access point STA 5 (AP 2)) for providing a distribution service, and a distribution system (DS) for connecting the multiple access points STA 2 (AP 1) and STA 5 (AP 2) to each other. In the BSS 2, the second access point STA 5 (AP 2) may manage the third terminal STA 3 and the fourth terminal STA 4.

BSS 3 denotes an IBSS operating in an ad-hoc mode. In the BSS 3, there is no access point that functions as a centralized management entity. That is, in the BSS 3, terminals STA 6, STA 7, and STA 8 are managed in a distributed manner. In the BSS 3, all of the terminals STA 6, STA 7, and STA 8 may denote mobile terminals, and access to the distribution system (DS) is not permitted, thus constituting a self-contained network.

The access points STA 2 (AP 1) and STA 5 (AP 2) may provide access to the distribution system (DS) via a wireless medium for the terminals STA 1, STA 3, and STA 4 connected thereto. Communication between the terminals STA 1, STA 3, and STA 4 in the BSS 1 or BSS 2 is generally performed via the access point STA 2 (AP 1) or STA 5 (AP 2), but direct communication may be performed between the terminals STA 1, STA 3, and STA 4 when a direct link is set up therebetween.

Multiple infrastructure BSSs may be connected to each other through the distribution system (DS). The multiple BSSs connected through the distribution system (DS) are called an extended service set (ESS). The entities included in the ESS, that is, STA 1, STA 2 (AP 1), STA 3, STA 4, and STA 5 (AP 2), are capable of communicating with each other, and any terminal STA 1, STA 3, or STA 4 may move from a single BSS to another BSS while performing seamless communication in the same ESS.

The distribution system (DS) is a mechanism for allowing one access point to communicate with another access point. In accordance with the DS, the access point may transmit frames for terminals coupled to a BSS managed thereby, or may transmit frames for any terminal that has moved to another BSS. Further, the access point may transmit and receive frames to and from an external network, such as a wired network. Such a DS is not necessarily a network and is not limited in its form as long as it is capable of providing a predetermined distribution service defined in the IEEE 802.11 standards. For example, the distribution system may be a wireless network such as a mesh network, or a physical structure for connecting the access points to each other.

Each terminal (STA) in the infrastructure BSS may be associated with an access point (AP). When associated with the access point (AP), the terminal (STA) may transmit and receive data.

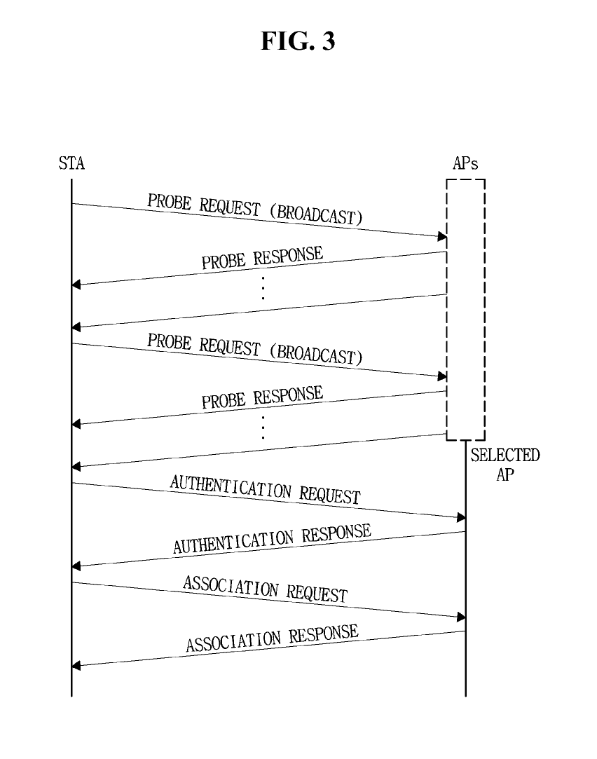

FIG. 3 is a flowchart showing a terminal association procedure performed in an infrastructure BSS.

Referring to FIG. 3, the STA association procedure performed in the infrastructure IBSS may be chiefly divided into the step of probing an AP (probe step), the step of performing authentication with the probed AP (authentication step), and the step of associating with the AP with which authentication has been performed (association step).

The terminal (STA) may first probe neighboring APs using a passive scanning method or an active scanning method. When the passive scanning method is used, the terminal (STA) may probe neighboring APs by overhearing the beacons transmitted from the APs. When the active scanning method is used, the STA may probe neighboring APs by transmitting a probe request frame and receiving a probe response frame which is a response to the probe request frame from the APs.

When neighboring APs are detected, the STA may perform the step of performing authentication with each detected AP. In this case, the STA may perform the step of performing authentication with multiple APs. Authentication algorithms conforming to the IEEE 802.11 standards may be classified into an open system algorithm for exchanging two authentication frames with each other and a shared key algorithm for exchanging four authentication frames with each other.

Based on the authentication algorithms conforming to the IEEE 802.11 standards, the STA may transmit an authentication request frame and receive an authentication response frame, which is a response to the authentication request frame, from each AP, thus completing authentication with each AP.

When authentication has been completed, the STA may perform the step of associating with the AP. In this case, the STA may select a single AP from among the APs with which authentication has been performed, and may perform the step of associating with the selected AP. That is, the STA may transmit an association request frame to the selected AP and receive an association response frame, which is a response to the association request frame, from the selected AP, thus completing association with the selected AP.

The WLAN system denotes a local area network in which multiple communication entities conforming to the IEEE 802.11 standards may exchange data with each other in a wirelessly connected state.

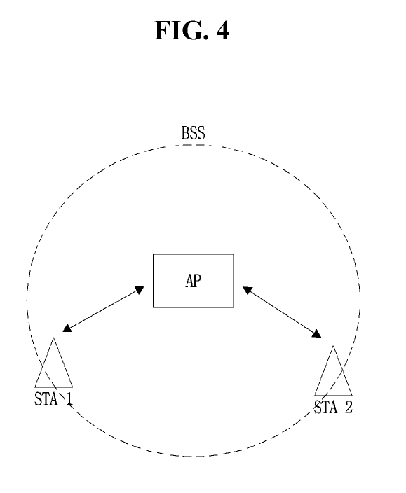

FIG. 4 is a conceptual diagram showing the infrastructure BSS of a WLAN system.

Referring to FIG. 4, the infrastructure BSS may include a single access point (AP) and multiple terminals STA 1 and STA 2. The AP may transmit a beacon frame including a service set ID (SSID), which is a unique identifier, in a broadcast manner. The beacon frame may provide information about the presence and association of the AP to terminals that are not associated with the AP, and may notify the terminals associated with the AP of the presence of data that is transmitted to a specific terminal.

Each terminal that is not associated with the AP may probe the AP using a passive scanning method or an active scanning method, and may acquire association information from the probed AP. In the case of the passive scanning method, the terminal may probe the AP by receiving a beacon frame from the AP. In the case of the active scanning method, the terminal may probe the AP by transmitting a probe request frame and receiving a probe response frame, which is a response thereto, from the AP.

Each terminal that is not associated with the AP may attempt to perform authentication with a specific AP based on association information acquired from the beacon frame or the probe response frame. A terminal that has succeeded in authentication may transmit an association request frame to the corresponding AP, and the AP, having received the association request frame, may transmit an association response frame including the AID of the terminal to the terminal. Via the above procedure, the terminal may be associated with the AP.

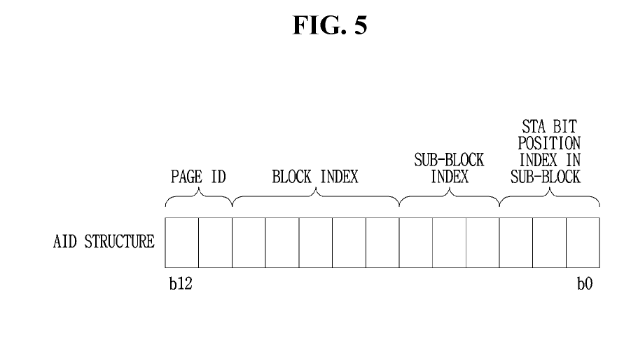

FIG. 5 is a block diagram showing an embodiment of a hierarchical AID structure.

Referring to FIG. 5, in the IEEE 802.11 standards, an AID having a hierarchical structure may be used to efficiently manage multiple terminals. An AID assigned to a single terminal may be composed of a page ID, a block index, a sub-block index, and a terminal index (STA index). The group to which the terminal belongs (i.e. a page group, a block group, or a sub-block group) may be identified using information about individual fields.

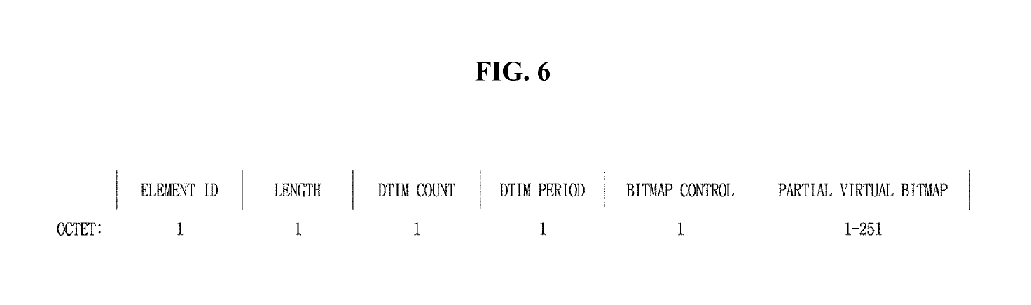

FIG. 6 is a block diagram showing an embodiment of the structure of a traffic indication map (TIM) information element (IE).

Referring to FIG. 6, the TIM IE may include an element ID field, a length field, a delivery traffic indication message (DTIM) count field, a DTIM period field, a bitmap control field, and a partial virtual bitmap field. That is, the TIM IE includes information required to indicate a bit corresponding to the AID of a terminal when data to be transmitted to the terminal is buffered in the AP, and this information may be encoded into the bitmap control field and the partial virtual bitmap field.

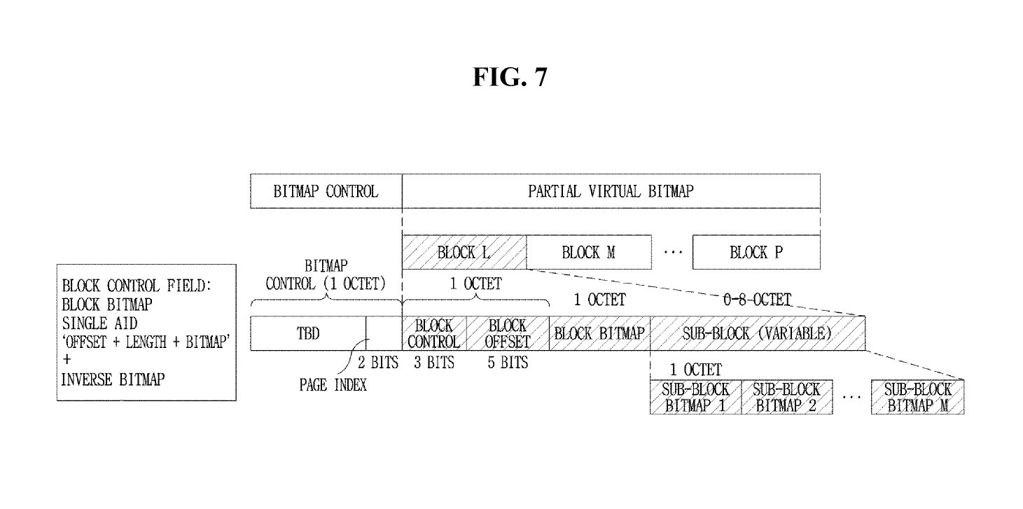

FIG. 7 is a block diagram showing an embodiment of the structure of a TIM encoded on a block basis.

Referring to FIG. 7, in the IEEE 802.11 standards, the TIM may be encoded on a block basis. A single encoding block may include a block control field, a block offset field, a block bitmap field, and at least one sub-block field.

The block control field may denote the encoding mode of the TIM. That is, the block control field may represent a block bitmap mode, a single AID mode, an offset+length+bitmap (OLB) mode, or an inverse bitmap mode. The block offset field may represent the offset of an encoded block. The block bitmap field may represent a bitmap indicating the location of the sub-block in which an AID bit is set. The sub-block bitmap field may represent a bitmap indicating the location of an AID in the sub-block.

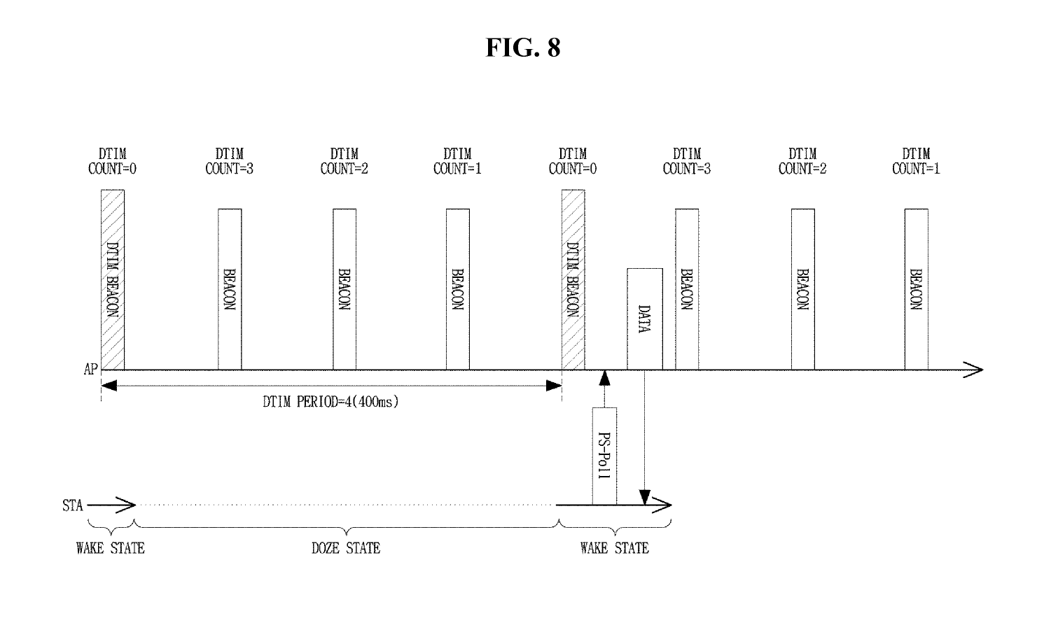

FIG. 8 is a flow diagram showing an embodiment of a data transmission/reception procedure.

Referring to FIG. 8, an access point (AP) may transmit a beacon frame including a TIM IE in a broadcast manner. A terminal (STA) operating in a power save mode may awake at intervals of a beacon period, in which a DTIM count becomes 0, and may receive a beacon frame. The terminal (STA) is configured to, when a bit corresponding to its AID is set to ‘1’ in the TIM included in the received beacon frame, transmit a PS-Poll frame to the AP, thus notifying the AP that the STA is ready to receive data. Upon receiving the PS-Poll frame, the AP may transmit a data frame to the corresponding STA.

In the WLAN system, communication entities (i.e. access points, terminals, etc.) share a wireless channel and contend with other entities to access the wireless channel based on a carrier sense multiple access (CSMA)/collision avoidance (CA) scheme. First, each communication entity may check the occupied state of the wireless channel using a physical channel sensing scheme and a virtual channel sensing scheme before accessing the wireless channel.

The physical channel sensing scheme may be implemented via channel sensing, which detects whether energy of a predetermined level or more is present in the wireless channel. When energy of a predetermined level or more is detected using the physical channel sensing scheme, the terminal may determine that the wireless channel is occupied by another terminal, and thus may perform again channel sensing after waiting for a random backoff time. Meanwhile, when energy of less than a predetermined level is detected using the physical channel sensing scheme, the terminal may determine that the wireless channel is in an idle state, and may then access the corresponding wireless channel and transmit a signal through the wireless channel.

The virtual channel sensing scheme may be implemented by setting a predicted channel occupation time using a network allocation vector (NAV) timer. In the WLAN system, upon transmitting a frame, a communication entity may write the time required to complete the transmission of the corresponding frame in the duration field of the header of the frame. When normally receiving a certain frame through the wireless channel, the communication entity may set its own NAV timer based on a value in the duration field of the header of the received frame. When receiving a new frame before the NAV timer has expired, the communication entity may update the NAV timer based on the value in the duration field of the header of the newly received frame. When the NAV timer has expired, the communication entity may determine that the occupation of the wireless channel has been released, and may then contend for access to a wireless channel.

The communication entity may support multiple data rates of a physical layer depending on various modulation schemes and various channel coding rates. Generally, a high data rate for the physical layer enables a large amount of data to be transmitted during a short wireless channel occupation time, but requires high signal quality. In contrast, a low data rate for the physical layer enables data to be transmitted even at low signal quality, but requires a relatively long wireless channel occupation time.

Since the resources of the wireless channel are shared between communication entities, the overall capacity of the WLAN system may be increased only when the maximum amount of data is transmitted during the time for which a specific communication entity occupies the wireless channel. That is, the overall capacity of the WLAN system may be increased when the terminal transmits and receives data to and from the AP at the highest possible data rate for the physical layer. The highest data rate for the physical layer may be realized when signal quality is sufficiently secured owing to a short distance between the AP and the terminal. If the terminals are located far away from the AP, the data rate of the physical layer becomes low, thus resulting in the reduction of the overall capacity of the WLAN system.

In the WLAN system for providing a communication service to multiple sensor terminals located over a wide area, there may occur the case where data cannot be transmitted to the entire area using only the signal output of a single AP. That is, sensor terminals that cannot be supported with a communication service may be present. Meanwhile, since a low-power sensor terminal has low signal output, the range in which the WLAN system is capable of transmitting uplink data may be further narrowed.

In particular, since a terminal located in the coverage boundary of the AP exhibits poor signal quality, the terminal performs communication with the AP at a low data rate of the physical layer. Therefore, the overall capacity of the WLAN system is drastically decreased. Further, when using the low data rate of the physical layer, the low-power terminal must be awake for a much longer time in order to transmit the same amount of data, thus increasing power consumption.

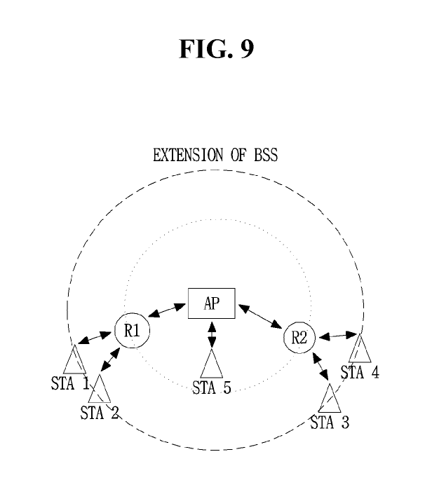

FIG. 9 is a conceptual diagram showing a WLAN system using relay devices.

Referring to FIG. 9, relay devices R1 and R2 may be arranged at the location where signal quality is deteriorated between an AP and terminals STA 1, STA 2, STA 3, and STA 4. The first relay device R1 may relay data transmitted between the AP and the first and second terminals STA 1 and STA 2. The second relay device R2 may relay data transmitted between the AP and the third and fourth terminals STA 3 and STA 4. That is, the physical area of the AP may be extended by the relay devices R1 and R2.

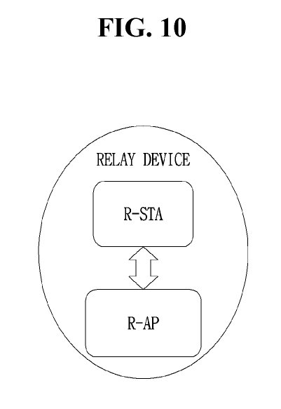

FIG. 10 is a block diagram showing the logical configuration of a relay device.

Referring to FIG. 10, the relay device may include a relay-terminal (R-STA), functioning as a terminal with respect to an AP, and a relay-access point (R-AP), functioning as an AP with respect to terminals present in an extended area.

The relay-terminal (R-STA) may probe an AP by receiving a beacon frame or a probe response frame transmitted from the AP using the same procedure as that of a normal terminal. Thereafter, the relay-terminal (R-STA) may sequentially perform a procedure for authentication with the probed AP and a procedure for association with the probed AP.

The relay terminal (R-STA) may relay data transmitted between the AP and an end terminal. In this case, the relay-terminal (R-STA) may relay data that is transmitted using a 4-address field. The 4-address field may include a destination address (DA) field, indicating the final destination address of data, a source address (SA) field, indicating the address of the place where the data was generated, a transmitter address (TA) field, indicating the address of the communication entity that physically transmitted the frame containing the data, and a receiver address (RA) field, indicating the address of the communication entity that is to physically receive the frame containing the data.

For example, the AP may configure the header address field of a data frame in the following manner and may then transmit the data frame when desiring to transmit data to the first terminal STA 1 via the first relay device R1.
DA field: address of first terminal STA 1
SA field: address of AP
TA field: address of AP
RA field: address of first relay device R1

The relay-terminal (R-STA) may forward the data frame received from the relay-access point (R-AP) to the AP, and may forward a data frame received from the AP to the R-AP.

When the relay-terminal (R-STA) and the AP are associated with each other and a transfer path is acquired, the relay-access point (R-AP) may periodically transmit a beacon frame including an identifier (SSID) identical to that of the AP. Also, the relay-access point (R-AP) may transmit a probe response frame in response to a probe request frame from the end terminal, transmit an authentication response frame in response to an authentication request frame from the end terminal, and transmit an association response frame in response to an association request frame from the end terminal. That is, the relay-access point (R-AP) may perform the same function as the AP.

An end terminal located near the relay device may be connected to a relay-AP (R-AP) located closer to the end terminal than the AP and may secure high signal quality, thus enabling data to be transmitted at a high data rate of the physical layer.

The relay-access point (R-AP) may generate a beacon frame including an indicator indicating that the R-AP itself is a communication entity for relaying data transmitted between the AP and the end terminal, and may transmit the generated beacon frame. Such an indicator may be defined either using one bit in the beacon frame or using the address field of the AP.

The relay-access point (R-AP) may transmit a data frame using a 4-address field in the same way as the relay-terminal (R-STA). Alternatively, the relay-access point (R-AP) may transmit a data frame using a 3-address field (SA=TA, RA, and DA) when the SA field is identical to the TA field.

The relay device simultaneously transmits frames received from multiple end terminals to the AP rather than transmitting a received frame to the AP whenever the frame is received from each end terminal.

The terminal functioning as a relay device has a small buffer. In this environment, when the state of the wireless channel between the relay device and the AP is deteriorated, latency in data transmission occurs, thus resulting in buffer overflows.

When a buffer overflow occurs, the relay device cannot receive the frame transmitted from the end terminal. In this case, since the end terminal cannot receive an ACK frame, which is a response to the transmitted frame, and cannot recognize that the failure to transmit the frame is due to a buffer overflow, it continuously retransmits the frame to the relay device. Due to this frame retransmission, the efficiency of use of the wireless channel is rapidly deteriorated. Also, the end terminal must be maintained in an awakened state in order to retransmit the frame, thus increasing power consumption.

The relay device may solve the above problem by controlling the traffic received from the end terminal.

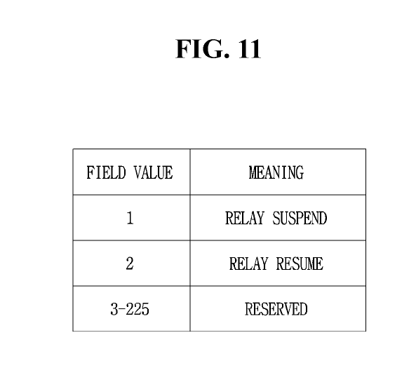

FIG. 11 is a table showing an example of a relay control frame.

Referring to FIG. 11, the relay control frame may include a relay suspend field, a relay resume field, and a reserved field. The relay device may request an end terminal to suspend the transmission of data to the relay device using the relay suspend field. The relay device may request the end terminal to resume the transmission of data to the relay device using the relay resume field.

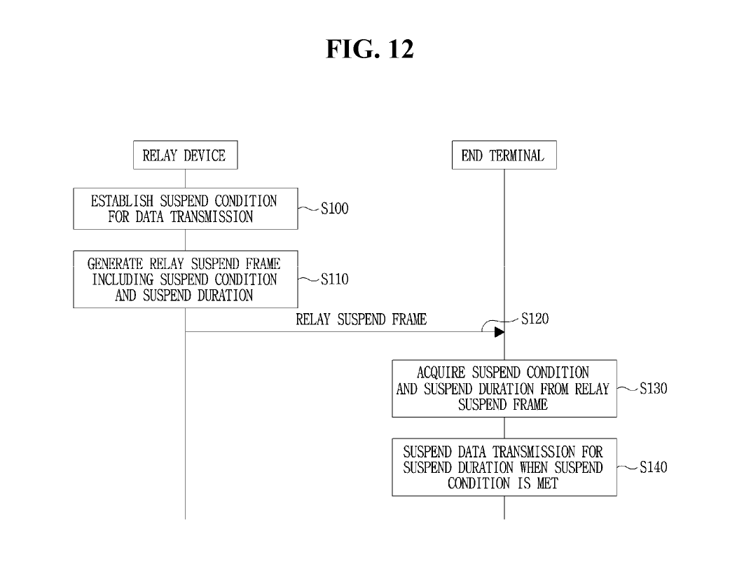

FIG. 12 is a flowchart showing a traffic control method according to an embodiment of the present invention.

Referring to FIG. 12, an end terminal may be connected to a relay device, and the relay device may relay data transmitted between an AP and the end terminal. The relay device may configure suspend conditions, required to suspend the transmission of data from the end terminal to the relay device (S100). That is, when data cannot be received from the end terminal any longer (for example, when a large amount of data is stored in a buffer), the relay device may configure suspend conditions.

Suspend conditions may be chiefly classified into a suspend condition based on terminal characteristics and a suspend condition based on traffic characteristics. The relay device may configure only the suspend condition based on terminal characteristics, only the suspend condition based on traffic characteristics, or both suspend conditions (i.e. terminal and traffic characteristics), or may configure neither of the suspend conditions.

The suspend condition based on terminal characteristics may include at least one of a group ID, an association ID (AID), a modulation and coding scheme (MSC) level, and a service type. In other words, the suspend condition based on terminal characteristics may denote a suspend condition for the transmission of data from each end terminal.

For example, the relay device may configure a suspend condition including a specific group ID when desiring to request an end terminal having the specific group ID to suspend the transmission of data. The relay device may configure a suspend condition including a specific AID when desiring to request an end terminal having the specific AID to suspend the transmission of data. The relay device may configure a suspend condition including a specific MCS level when desiring to request an end terminal supporting the specific MCS level or less to suspend the transmission of data. The relay device may configure a suspend condition including a specific service type when desiring to request an end terminal supporting the specific service type to suspend the transmission of data.

Here, the case where the suspend condition based on terminal characteristics is not configured may mean that the suspension of data transmission is requested from all end terminals.

Meanwhile, the suspend condition based on traffic characteristics may include at least one of the length of data to be transmitted, the amount of generated jitter, the amount of generated latency, and the traffic category. In other words, the suspend condition based on traffic characteristics may denote a suspend condition for the transmission of each piece of data from the corresponding terminal.

For example, when desiring to request the suspension of the transmission of data longer than a preset reference, the relay device may configure a suspend condition including a data length corresponding to the preset reference.

The relay device may configure a suspend condition including the amount of generated jitter corresponding to a preset reference. That is, when the buffer does not have any available space, the relay device may configure a suspend condition having a relatively small amount of generated jitter. If the suspend condition including the amount of generated jitter is configured in this way, the end terminal is configured to, when the amount of generated jitter in the data desired to be transmitted thereby is less than or equal to the amount of generated jitter included in the suspend condition, transmit the corresponding data to the relay device. In contrast, when the amount of generated jitter in the desired data is greater than the amount of generated jitter included in the suspend condition, the end terminal does not transmit the corresponding data to the relay device.

The relay device may configure a suspend condition including the amount of generated latency corresponding to a preset reference. That is, when the buffer does not have any available space, the relay device may configure a suspend condition including a relatively small amount of generated latency. If the suspend condition including the amount of generated latency is configured in this way, the end terminal is configured to, when the latency of the data desired to be transmitted thereby is less than or equal to the amount of generated latency included in the suspend condition, transmit the corresponding data to the relay device. In contrast, when the latency of the desired data is greater than the amount of generated latency included in the suspend condition, the end terminal does not transmit the corresponding data to the relay device.

When desiring to request the suspension of transmission of data corresponding to a specific traffic category (e.g. background data traffic or the like), the relay device may configure a suspend condition including the corresponding traffic category.

Here, the case where the suspend condition based on traffic characteristics is not configured may mean that the suspension of transmission of all pieces of data from the end terminal is requested.

The relay device may generate a relay suspend frame including both the configured suspend condition and a suspend duration for data transmission (S110).

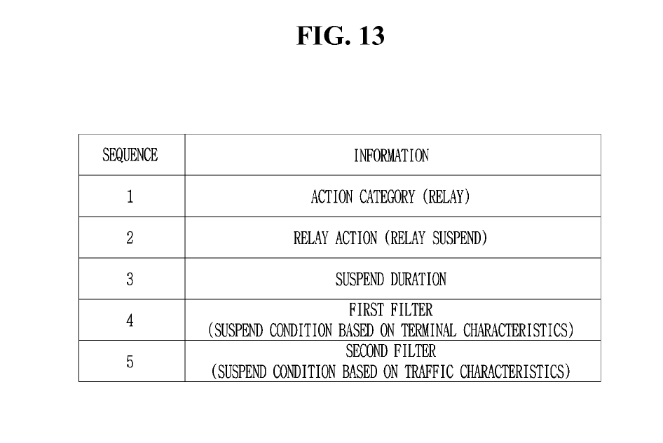

FIG. 13 is a table showing a relay suspend frame according to an embodiment of the present invention.

Referring to FIG. 13, the relay suspend frame may include action category information, relay action information, suspend duration information, first filter information (i.e. suspend condition based on terminal characteristics), and second filter information (i.e. suspend condition based on traffic characteristics).

The action category information may indicate that the corresponding action is performed by the relay device. The relay action information may indicate that the corresponding frame requests the suspension of data transmission. The suspend duration information may indicate a duration during which the transmission of data to the relay device is suspended.

The first filter information may indicate a suspend condition for data transmission based on terminal characteristics. For example, the first filter information may include at least one of a group ID, an AID, an MCS level, and a service type.

The second filter information may indicate a suspend condition for data transmission based on traffic characteristics. For example, the second filter information may include at least one of the length of data to be transmitted, the amount of generated jitter, the amount of generated latency, and the traffic category.

When only the suspend condition based on terminal characteristics is configured, the relay device may generate a relay suspend frame including first filter information, when only the suspend condition based on traffic characteristics is configured, the rely device may generate a relay suspend frame including second filter information, and when both suspend conditions are configured, the relay device may generate a relay suspend frame including both first filter information and second filter information.

Meanwhile, when desiring to request all end terminals to suspend the transmission of data, the relay device may not configure suspend conditions. That is, the relay device may request all of the end terminals to suspend the transmission of data by transmitting a relay suspend frame that does not include the first or second filter information.

Referring back to FIG. 12, the relay device may transmit the relay suspend frame (S120). In this case, the relay device may transmit the relay suspend frame to the end terminal in a broadcast or unicast manner.

When the relay suspend frame is received from the relay device, the end terminal may acquire a suspend condition and a suspend duration that are included in the received relay suspend frame (S130). That is, when a certain frame is received, the end terminal may determine that the certain frame is the relay suspend frame, based on action category information and relay action information included in the received certain frame, and may acquire the suspend condition and the suspend duration included in the relay suspend frame.

The end terminal is configured to, when it meets the suspend condition, suspend the transmission of data to the relay device for the suspend duration (S140). For example, when the relay suspend frame includes a suspend condition based on terminal characteristics, the end terminal may first determine whether it meets the suspend condition based on terminal characteristics. If the end terminal meets the suspend condition based on terminal characteristics, it may suspend the transmission of data to the relay device for the suspend duration. In contrast, if the end terminal does not meet the suspend condition based on terminal characteristics, it may transmit data to the relay device.

When the relay suspend frame includes a suspend condition based on traffic characteristics, the end terminal may first determine whether data to be transmitted thereby meets the suspend condition based on traffic characteristics. If the data to be transmitted meets the suspend condition based on traffic characteristics, the end terminal may not transmit data meeting the suspend condition to the relay device for the suspend duration. In contrast, the end terminal may transmit data that does not meet the suspend condition to the relay device.

When the relay suspend frame includes both the suspend conditions based on terminal and traffic characteristics, the end terminal may determine whether it meets both the suspend conditions based on terminal and traffic characteristics. If the end terminal meets the suspend condition based on terminal characteristics and data to be transmitted thereby meets the suspend condition based on traffic characteristics, the end terminal may not transmit the corresponding data to the relay device for the suspend duration. If the end terminal meets the suspend condition based on terminal characteristics and the data to be transmitted thereby does not meet the suspend condition based on traffic characteristics, the end terminal may transmit the corresponding data to the relay device. If the end terminal does not meet the suspend condition based on terminal characteristics, it may transmit the data to the relay device.

Meanwhile, when the relay suspend frame does not include suspend conditions, all end terminals having received the relay suspend frame may suspend the transmission of data to the relay device for the suspend duration.

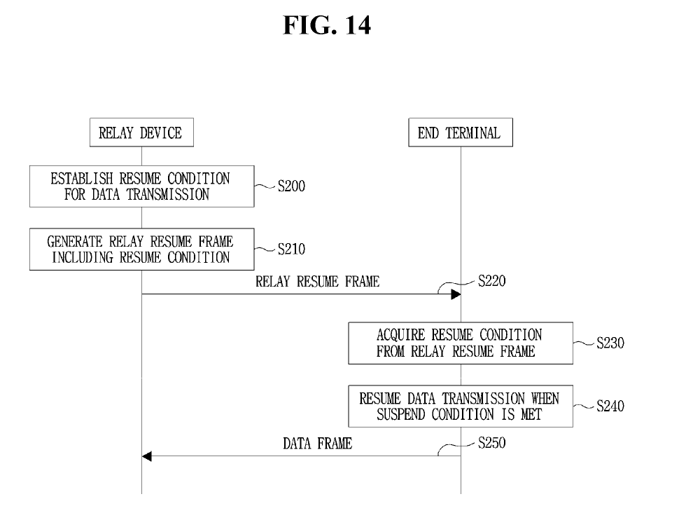

FIG. 14 is a flowchart showing a traffic control method according to another embodiment of the present invention.

Referring to FIG. 14, an end terminal may be connected to a relay device, and the relay device may relay data transmitted between an AP and the end terminal. The relay device may configure resume conditions, required to resume the transmission of data from the end terminal (S200). That is, when data can be received from the end terminal (e.g. when the buffer is empty), the relay device may configure resume conditions for the transmission of data from the end terminal.

Resume conditions may be chiefly classified into a resume condition based on terminal characteristics and a resume condition based on traffic characteristics. The relay device may configure only a resume condition based on terminal characteristics, only a resume condition based on traffic characteristics, or both resume conditions (i.e. terminal and traffic characteristics), or may configure neither of the resume conditions.

The resume condition based on terminal characteristics may include at least one of a group ID, an AID, an MCS level, and a service type. That is, the suspend condition based on terminal characteristics may denote the suspend condition for the transmission of data from each terminal.

For example, when desiring to request an end terminal having a specific group ID to resume the transmission of data, the relay device may configure a resume condition including the corresponding group ID. When desiring to request an end terminal having a specific AID to resume the transmission of data, the relay device may configure a resume condition including the corresponding AID. When desiring to request an end terminal supporting a specific MCS level or less to resume the transmission of data, the relay device may configure a resume condition including the corresponding MSC level. When desiring to request an end terminal supporting a specific service type to resume the transmission of data, the relay device may configure a resume condition including the corresponding service type.

Here, the case where the resume condition based on terminal characteristics is not configured may mean that the resumption of transmission is requested from all end terminals.

Meanwhile, the resume condition based on traffic characteristics may include at least one of the length of data to be transmitted, the amount of generated jitter, the amount of generated latency, and the traffic category. That is, the resume condition based on traffic characteristics may refer to the resume condition for the transmission of each piece of data from the corresponding terminal.

For example, when desiring to request the resumption of the transmission of data longer than a preset reference, the relay device may configure a resume condition including a data length corresponding to the preset reference.

The relay device may configure a resume condition including the amount of generated jitter corresponding to a preset reference. That is, when the buffer has any available space, the relay device may configure a resume condition having a mitigated amount of generated jitter. If the resume condition including the amount of generated jitter is configured in this way, the end terminal is configured to, when the amount of generated jitter in the data desired to be transmitted thereby is less than or equal to the amount of generated jitter included in the resume condition, transmit the corresponding data to the relay device.

The relay device may configure a resume condition including the amount of generated latency corresponding to a preset reference. That is, when the buffer has any available space, the relay device may configure a resume condition including a mitigated amount of generated latency. If the resume condition including the amount of generated latency is configured in this way, the end terminal is configured to, when the latency of the data desired to be transmitted thereby is less than or equal to the amount of generated latency included in the resume condition, transmit the corresponding data to the relay device.

When desiring to request the resumption of transmission of data corresponding to a specific traffic category (e.g. background data traffic or the like), the relay device may configure a resume condition including the corresponding traffic category.

Here, the case where the resume condition based on traffic characteristics is not configured may mean that the resumption of transmission of all pieces of data is requested.

The relay device may generate a relay suspend frame including the configured resume condition (S110).

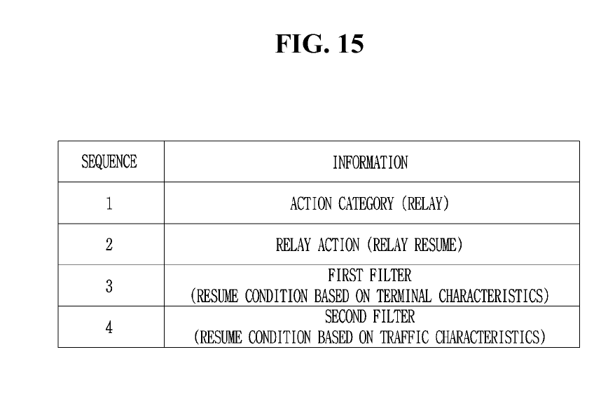

FIG. 15 is a table showing a relay resume frame according to an embodiment of the present invention.

Referring to FIG. 15, the relay resume frame may include action category information, relay action information, first filter information (i.e. resume condition based on terminal characteristics), and second filter information (i.e. resume condition based on traffic characteristics).

The action category information may indicate that the corresponding action is performed by the relay device. The relay action information may indicate that the corresponding frame requests the resumption of data transmission.

The first filter information may indicate a resume condition for data transmission based on terminal characteristics. For example, the first filter information may include at least one of a group ID, an AID, an MCS level, and a service type.

The second filter information may indicate a resume condition for data transmission based on traffic characteristics. For example, the second filter information may include at least one of the length of data to be transmitted, the amount of generated jitter, the amount of generated latency, and the traffic category.

When only the resume condition based on terminal characteristics is configured, the relay device may generate a relay resume frame including first filter information, when only the resume condition based on traffic characteristics is configured, the rely device may generate a relay resume frame including second filter information, and when both resume conditions are configured, the relay device may generate a relay resume frame including both first filter information and second filter information.

Meanwhile, when desiring to request all end terminals to resume the transmission of data, the relay device may not configure resume conditions. That is, the relay device may request all of the end terminals to resume the transmission of data by transmitting a relay resume frame that does not include the first or second filter information.

Referring back to FIG. 14, the relay device may transmit the relay resume frame (S220). In this case, the relay device may transmit the relay resume frame to the end terminal in a broadcast or unicast manner.

When the relay resume frame is received from the relay device, the end terminal may acquire a resume condition included in the received relay resume frame (S230). That is, when a certain frame is received, the end terminal may determine that the certain frame is the relay resume frame, based on action category information and relay action information included in the received certain frame, and may acquire the resume condition included in the relay resume frame.

The end terminal is configured to, when it meets the resume condition, resume the transmission of data to the relay device (S240). For example, when the relay resume frame includes a resume condition based on terminal characteristics, the end terminal may first determine whether it meets the resume condition based on terminal characteristics. If the end terminal meets the resume condition based on terminal characteristics, it may resume the transmission of data to the relay device. In contrast, if the end terminal does not meet the resume condition based on terminal characteristics, it may not transmit data to the relay device.

When the relay resume frame includes a resume condition based on traffic characteristics, the end terminal may first determine whether data to be transmitted thereby meets the resume condition based on traffic characteristics. If the data to be transmitted meets the resume condition based on traffic characteristics, the end terminal may transmit the corresponding data to the relay device. In contrast, if the data to be transmitted does not meet the resume condition based on traffic characteristics, the end terminal may not transmit the corresponding data to the relay device.

When the relay resume frame includes both the resume conditions based on terminal and traffic characteristics, the end terminal may determine whether it meets both the resume conditions based on terminal and traffic characteristics. If the end terminal meets the resume condition based on terminal characteristics and data to be transmitted thereby meets the resume condition based on traffic characteristics, the end terminal may transmit the corresponding data to the relay device. If the end terminal meets the resume condition based on terminal characteristics and the data to be transmitted thereby does not meet the resume condition based on traffic characteristics, the end terminal may not transmit the corresponding data to the relay device. If the end terminal does not meet the resume condition based on terminal characteristics, it may not transmit the data to the relay device.

Meanwhile, when the relay resume frame does not include resume conditions, all end terminals having received the relay resume frame may resume the transmission of data to the relay device.

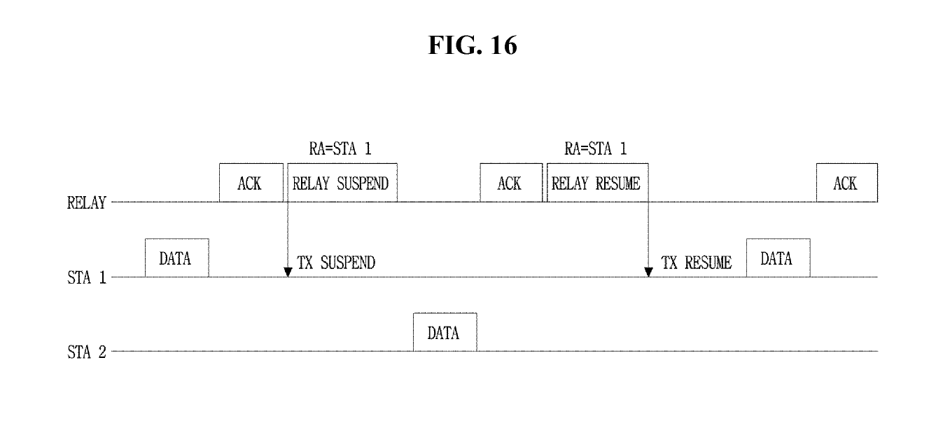

FIG. 16 is a flowchart showing a relay traffic control procedure according to an embodiment of the present invention.

Referring to FIG. 16, terminals STA 1 and STA 2 are connected to a relay device (relay), and the relay device may relay data transmitted between an AP and the terminals STA 1 and STA 2. When desiring to request the first terminal STA 1 to suspend the transmission of data, the relay device may transmit a relay suspend frame to the first terminal STA 1 in a unicast manner. When receiving the relay suspend frame from the relay device, the first terminal STA 1 may suspend the transmission of data for a preset suspend duration.

Meanwhile, when desiring to request the first terminal STA 1 to resume the transmission of data, the relay device may transmit a relay resume frame to the first terminal STA 1 in a unicast manner. When receiving the relay resume frame from the relay device, the first terminal STA 1 may transmit the data to the relay device.

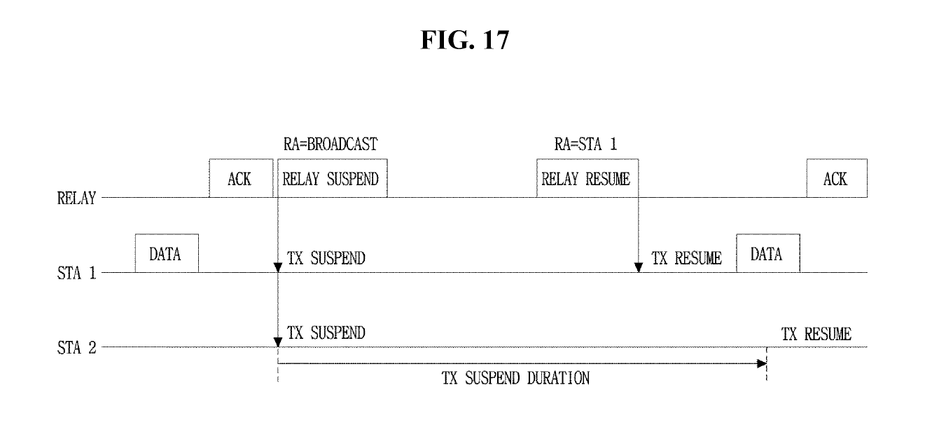

FIG. 17 is a flowchart showing a relay traffic control procedure according to another embodiment of the present invention.

Referring to FIG. 17, terminals STA 1 and STA 2 may be connected to a relay device (relay), and the relay device may relay data transmitted between an AP and the terminals STA 1 and STA 2. When requesting all of the terminals STA 1 and STA 2 connected to the relay device itself to suspend the transmission of data, the relay device may transmit a relay suspend frame in a broadcast manner. Upon receiving the relay suspend frame from the relay device, the terminals STA 1 and STA 2 may suspend the transmission of data for a preset suspend duration.

Meanwhile, when requesting only the first terminal STA 1 to resume the transmission of data, the relay device may transmit a relay resume frame to the first terminal STA 1 in a unicast manner. When receiving the relay resume frame from the relay device, the first terminal STA 1 may transmit the data to the relay device. The second terminal STA 2 may transmit data to the relay device after a preset suspend duration has elapsed.

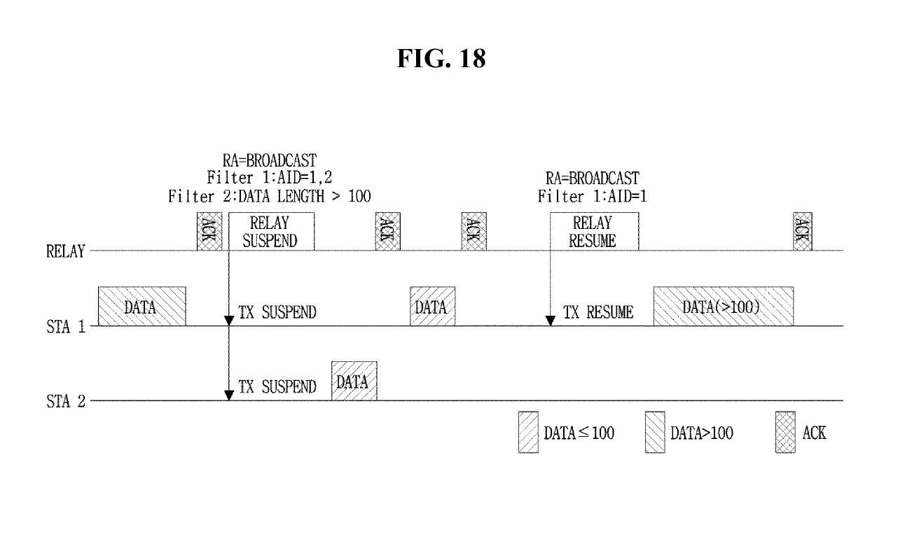

FIG. 18 is a flowchart showing a relay traffic control procedure according to a further embodiment of the present invention.

Referring to FIG. 18, a relay device may relay data transmitted between an AP and terminals STA 1 and STA 2. The terminals STA 1 and STA 2 may be connected to the relay device, wherein the first terminal STA 1 has an AID of 1 and the second terminal STA 2 has an AID of 2.

When desiring to request the suspension of the transmission of data, the length of which exceeds 100 bytes, among pieces of data transmitted from specific terminals (i.e. having AIDs of 1 and 2), the relay device may configure a suspend condition based on terminal characteristics (i.e. corresponding to AIDs of 1 and 2) and a suspend condition based on traffic characteristics (i.e. data length>100 bytes), and may transmit a relay suspend frame including the configured suspend conditions (i.e. first filter (filter 1) and second filter (filter 2)) in a broadcast manner.

When receiving the relay suspend frame, the terminals STA 1 and STA 2 may recognize that they meet the suspend condition based on terminal characteristics, and thus may not transmit data, the length of which exceeds 100 bytes, for a preset suspend duration. That is, the terminals STA 1 and STA 2 may transmit only data, the length of which is less than or equal to 100 bytes, to the relay device for the preset suspend duration.

When desiring to request only the terminal STA 1 having an AID of 1 to resume the transmission of data, the relay device may configure a resume condition based on terminal characteristics (i.e. corresponding to an AID of 1), and may transmit a relay resume frame including the configured resume condition in a broadcast manner.

When receiving the relay resume frame, the first terminal STA 1 may recognize that it meets the resume condition based on terminal characteristics, and thus may transmit all pieces of data to the relay device regardless of the length of the data. In contrast, when receiving the relay resume frame, the second terminal STA 2 may recognize that it does not meet the resume condition based on terminal characteristics, and thus may not transmit data, the length of which exceeds 100 bytes, for the preset suspend duration.

The embodiments of the present invention may be implemented in the form of program instructions that are executable via various types of computer means, and may be recorded on a computer-readable medium. The computer-readable medium may include program instructions, data files, and data structures solely or in combination. Program instructions recorded on the computer-readable medium may have been specially designed and configured for the embodiments of the present invention, or may be known to or available to those who have ordinary knowledge in the field of computer software.

Examples of the computer-readable storage medium include all types of hardware devices specially configured to store and execute program instructions, such as read only memory (ROM), random access memory (RAM), and flash memory. The hardware devices may be configured to operate as one or more software modules in order to perform the operation according to embodiments of the present invention, and vice versa. Examples of the program instructions include machine language code, such as code created by a compiler, and high-level language code executable by a computer using an interpreter or the like.

Although the present invention has been described with reference to the embodiments, those skilled in the art will appreciate that the present invention can be modified and changed in various forms, without departing from the spirit and scope of the invention as disclosed in the accompanying claims.

1. A method for traffic control by an access point, the method comprising:
configuring a suspend condition for suspending data transmission from a terminal to the access point;
generating a suspend frame including the suspend condition and a suspend duration for data transmission; and
transmitting the suspend frame.

2. The method of claim 1, wherein the suspend condition is configured to suspend data transmission of a specific terminal.

3. The method of claim 1, wherein the suspend condition is configured to suspend transmission of specific data.

4. The method of claim 1, wherein the suspend condition includes at least one of a group ID, an association ID (AID), a modulation and coding scheme (MCS) level, and a service type.

5. The method of claim 1, wherein the suspend condition includes at least one of length of data to be transmitted, a amount of generated jitter, a amount of generated latency, and a traffic category.

6. A method for transmitting data by a terminal and, the method comprising:
receiving a suspend frame from an access point;
acquiring a suspend condition for suspending data transmission from the terminal to the access point, and a suspend duration for data transmission, the suspend condition and the suspend duration being included in the suspend frame; and
suspending data transmission to the access point during the suspend duration when the suspend condition is met.

7. The method of claim 6, wherein the suspend condition is configured to suspend data transmission of a specific terminal.

8. The method of claim 6, wherein the suspend condition is configured to suspend transmission of specific data.

9. A method for traffic control by an access point, the method comprising:
determining a resume condition for resuming data transmission from a terminal to the access point;
generating a resume frame including the resume condition; and
transmitting the resume frame.

10. The method of claim 9, wherein the resume condition is configured to resume transmission from a specific terminal.

11. The method of claim 9, wherein the resume condition is configured to resume transmission of specific data.

12. The method of claim 9, wherein the resume condition includes at least one of a group ID, an association ID (AID), a modulation and coding scheme (MCS) level, and a service type.

13. The method of claim 9, wherein the resume condition includes at least one of length of data to be transmitted, an amount of generated jitter, an amount of generated latency, and a traffic category.

14. A method for transmitting data by a terminal and, the method comprising:
receiving a resume frame from an access point;
acquiring a resume condition for resuming data transmission from the terminal to the access point, the resume condition being included in the resume frame; and
resuming data transmission to the access point when the resume condition is met.

15. The method of claim 14, wherein the resume condition is configured to resume transmission from a specific terminal.

16. The method of claim 14, wherein the resume condition is configured to resume transmission of specific data.
